(19) United States
(12) Patent Application Publication
(10) Pub. No.: US 2007/0155845 A1
(43) Pub. Date: Jul. 5, 2007

(54) Non-halogenated flame retardent composition and polyurethane foam containing same

(76) Inventors: Emmanuel Pinzoni, Hawthorne, NJ (US); Larry L. Bradford, Lufkin, TX (US)

Correspondence Address: DILWORTH & BARRESE, LLP, 333 EARLE OVINGTON BLVD., SUITE 702, UNIONDALE, NY, 11553, US

(21) Appl. No.: 10/569,697

(22) PCT Filed: Aug. 26, 2004
(86) PCT No.: PCT/US04/27788

§ 371 Date: Nov. 15, 2006

Related U.S. Application Data
(60) Provisional application No. 60/498,798, filed on Aug. 29, 2003.

(51) Int. Cl. C08J 9/00; C09K 21/00

(52) U.S. Cl. 521/128; 252/601

(57) ABSTRACT

A flame retardant composition especially useful for imparting flame retardancy to polyurethane foams includes: a) a major amount by weight of at least one polyphosphate ester flame retardant of the formula: wherein R is an alkylene or arylene group, each R₁ is independently selected to be an alkyl or aryl group, and n is an integer of from 1 to about 10; and b) a minor amount by weight of melamine.

### CROSS REFERENCE TO RELATED APPLICATION

This application claims the benefit of Provisional U.S. Patent Application Ser. No. 60/498,798, filed Aug. 29, 2003, the entire contents of which are incorporated by reference herein.

### BACKGROUND OF THE INVENTION

This invention relates to flame retardant compositions for incorporation in polyurethane foam. More particularly, the invention relates to blends of phosphate ester and melamine and the use of such blends as flame retardants for polyurethane foams.

Flexible polyurethane foams are widely used as cushioning or padding materials in fuiniture. Flame retardants are generally incorporated in such foams. However, it is difficult to identify a flame retardant that will achieve adequate fire retardancy economically without impacting negatively on the physical properties of polyurethane foams.

Various prior art disclosures exist in regard to the use of melamine as a flame retardant additive for polymers such as polyurethane foams. Some representative examples of such disclosures include the following:

U.S. Reissue Pat. No. 36,358 describes flame retardant polyurethane foams prepared by the reaction of a polyoxyalkylene polyether polyol with an organic polyisocyanate and a blowing agent wherein 10% to 55% of melamine is incorporated as the sole flame retardant compound.

U.S. Pat. Nos. 4,849,459 and 5,730,909 describe flame retardant flexible polyurethane foams prepared by reacting a polyether polyol, an organic isocyanate, a blowing agent and melamine together with an effective amount of a halogenated phosphate ester flame retardant such as the FYROL CEF, DE60F, FYROL PCF, and THERMOLIN 101 brand products.

U.S. Pat. Nos. 5,506,278 and 5,569,682 describe flame-retardant polyurethane foams comprising melamine and chlorinated phosphate esters such as the THERMOLIN 101 and FYROL CEF brand products.

U.S. Pat. No. 5,885,479 indicates that other flame retardants such as tricresyl phosphate, tris(2-chloroethyl)phosphate, tris(2-chloropropyl)phosphate, tris(1,3-dichloropropyl)phosphate, tris(2,3-dibromopropyl)phosphate and tetrakis(2-chloroethyl)ethylene diphosphate can be used in combination with melamine.

U.S. Pat. No. 4,757,093 discloses the replacement of a certain proportion of the liquid phosphorus ester flame retardant normally employed in polyurethane foams with melamine. Non-halogenated polyphosphate flame retardants are not disclosed in this patent and the examples suggest that the density of the foams that were treated were above 1.5 pounds per cubic foot (lb/ft³), specifically from 1.56 to 1.72 lb/ft³.

The fire retardants used by the flexible slab industry in the United States are primarily intended to meet two flammability tests: the MVSS302 test used by the automotive industry and the California Bureau of Home Furnishings 117A&D test (actually a combination of two tests). This technology is currently dominated by two fire retardant compositions: tris dichloropropyl phosphate or “TDCP” (such as FYROL® FR-2 brand product) and a blend of pentabromodiphenyloxide and a triarylphosphate (such as FYROL® PBR brand product).

### BRIEF SUMMARY OF TH INVENTION

In accordance with the present invention, there is provided a flame retardant composition comprising:

a) a major amount by weight of at least one polyphosphate ester flame retardant of the formula: 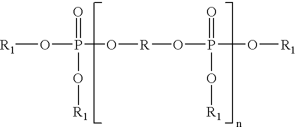
wherein R is an alkylene or arylene group, each R₁ is independently selected to be an alkyl or aryl group, and n is an integer of from 1 to about 10; and,

b) a minor amount by weight of melamine.

Further in accordance with the invention, the foregoing composition is incorporated in a flame retardant-effective amount in a polyurethane foam.

Although many types of polyurethane foam can pass the flammability test employing just the polyphosphate ester(s), supra, e.g., neopentyl glycol bis(diphenyl phosphate), it has been found herein that the use of a major amount by weight of such polyphosphate ester(s) in combination with a minor amount by weight of melamine results in a polyurethane foam with significantly improved smoldering properties in the CAL 117 A/D test and an appreciable decrease in burn length in the MVSS 302 test.

### DETAILED DESCRIPTION OF THE INVENTION

The polyphosphate ester flame retardants contained in the flame retardant composition herein are known, e.g., from U.S. Pat. Nos. 5,457,221 and 5,958,993, the entire contents of which are incorporated by reference herein.

In the formula of the polyphosphate ester flame retardant, supra, R is preferably selected to be alkylene of from 2 to about 20 carbon atoms or unsubstituted or lower alkyl-substituted arylene of from 6 to about 20 carbon atoms, and each R₁ is preferably selected from the group consisting of alkyl of from 1 to about 10 carbon atoms, unsubstituted aryl of from 6 to about 20 carbon atoms and lower alkyl-substituted aryl of from 6 to about 20 carbon atoms. In the more preferred polyphosphate ester flame retardants, R is an alkylene group of from 2 to about 8 carbon atoms, e.g., ethylene, propylene, butylene, pentylene, etc., or a phenylene group, and each R¹ is a phenyl group.

The expression “lower alkyl” shall be understood herein to include alkyl groups containing from 1 to 4 carbon atoms.

Specific examples of polyphosphate ester flame retardants for inclusion in the fire retardant composition of this invention include the aforementioned neopentyl glycol bis(diphenyl phosphate); resorcinol bis(diphenyl phosphate); ethylene glycol bis(diphenyl phosphate); propylene glycol bis(diphenyl phosphate); bisphenol A bis(diphenyl phosphate, and the like.

The flame retardant composition of this invention will contain a major amount by weight of polyphosphate ester flame retardant(s), preferably from about 55 to about 99.5 weight % polyphosphate ester(s) and more preferably from about 80 to about 99 weight % polyphosphate ester(s), with the balance being melamine. The polyphosphate ester(s) and melamine components of the flame retardant composition can be added to the polyurethane-foam forming reaction medium, preferably the polyol component thereof, either sequentially in any order or as a blend. The amount of combined polyphosphate ester(s) and melamine can vary widely, e.g., from about 5 to about 50, and preferably from about 10 to about 30, parts by weight per 100 parts by weight of the polyol component of the polyurethane foam-forming reaction medium.

The polyurethane foams incorporating the flame retardant composition of this invention generally have densities that are below about 1.5 lb/ft³ and typically have densities of less than about 1.2 lb/ft³.

In the examples that follow, flame retardant test data were generated using a typical polyether polyurethane flexible foam that was tested at nominal densities of 1.0, 1.5 and 1.8 lb/ft³. The formulations used to make the foams were formed using a polyether polyol having a hydroxyl number of 56, a water level of from 3.55% to 5.6%, an amine level of about 0.25% and an NCO index of 110.

The following standard tests were employed:

A. MVSS 302 Test: This test is a horizontal flame test that is used as a guideline for automobile manufactures. The sample size was 14″×4″×12″. There is a line 1½″ from the ignition point. A flame was ignited for fifteen seconds. The ignition source was then turned off and the sample was rated. A “DNI” rating indicates that the sample did not support combustion (“did not ignite”). A rating of “SE” indicates that the sample ignited but did not burn to the timing zone which is a point starting from the 1½″ mark to the 3½″ line. A rating of “SENBR” indicates that the sample burned past the 1½″ line but was extinguished before the 3½″ mark. A rating of “SE/B” indicates that a sample burned past the 3½″ mark but was extinguished before the endpoint. An inch per minute rate was then calculated. The burn rate indicates that a sample burned passed the 3½″ mark. An indication of a burn rate or an SE/B rating that was higher than 4.0 in/min indicates failure in accordance with this test. For this study a minimum performance of SENBR was required.

B. Cal. TB 117 A Test: This test is a small-scale vertical test with a twelve-second-ignition time. The sample size was 12″×3″×½″. The ignition source was removed after twelve seconds. A second clock is started if the sample continues to burn. The criteria for failing included: a sample exceeding an individual burn of eight inches or an average burns of six inches. The time criteria required that an individual specimen would not have an individual afterflame or afterglow exceeding ten seconds or an average afterflame or afterglow exceeding five seconds.

C. Cal. TB 117 D Test: This test is a smoldering test in which a cigarette is used as the ignition source under a cotton cloth cover. The foam sample was covered with a standard velvet cotton cloth and was placed in a small wooden frame to form a mock chair. The back of the sample was 8″×7″×2″ and the seat was 8″×4″×2″. The sample was preweighed before testing and was again weighed after the test was finished. If the foam lost more than 20% of its weight, it was judged to be a failure.

Neopentyl glycol bis(diphenyl phosphate) (“NDP”) was used in the Cal. TB-1 17 and MVSS 302 tests in several foams, either alone or in combination with melamine, as further described below.

Since the Cal. TB 117 Test requires passing two very different tests (Parts A and D), the effect of each flame retardant package on each test must be considered. For example, at low densities, it is easier to pass the smoldering test (Part D) and at higher density it is easier to pass the flaming test (Part A).

The general formulation of the polyurethane foam-forming reaction media and the general foam-forming procedure were as follows:

A. Polyurethane Foam-Forming Reaction
Medium (TDI Index of 110)

| | | |
|---|---|---|
| | | Foam Density |
| Component | Amount | range, lb/ft³ |

| Polyether Polyol | 100.0 | gm | — |
|---|---|---|---|
| (3000 mw) from Arco | | | |
| Flame Retardant(s) | Tables 1 and 2, infra | | — |
| Water | 5.6-3.55 | gm | 1.0-1.8 |
| Dabco 33LV from Air | 0.22 | gm | — |
| Products/Niax A-1 | | | |
| from OSI in a 3:1 | | | |
| weight ratio | | | |
| Silicone surfactant | 0.80-1.20 | gm | — |
| L-620 from OSI | | | |
| Stannous Octoate T-10 | 0.4-0.6 | gm | — |
| from Air Products | | | |
| Toluene Diisocyanate | 71.0-46.0 | gm | — |
| TDI from Bayer | | | |

B. Polyurethane Foam-Forming Procedure

The polyol, flame-retardant(s), water, amine catalyst and silicone surfactant were mixed, with stirring, in a first beaker. In a separate beaker, the toluene diisocyanate (TDI) was weighed out. The organo-tin catalyst was placed in a syringe. The first beaker was stirred at 2100 revolutions per minute for a period of ten seconds and the organo-tin catalyst was then dosed thereto while stirring was continued. After a total of about twenty seconds of stirring, the TDI was added to the mixture. Stirring was then continued for about an additional ten seconds, the still-fluid mixture was quickly put into a 16 inch×16 inch×5 inch box, and then the cream and rise time were measured. Once the foam ceased to rise, the foam was placed in an oven at 70° C. for 20 minutes to cure.

The following data illustrates that relative performance of flame retardant additives varies with foam densities as well as test method and that the described blends resulted in unexpected synergism in some of these combinations. (As density increases, less flame retardant additive is usually required to meet a specific test).

### EXAMPLES 1-7

### Cal 117 A/D Test Data

The data in Table 1 illustrate the parts of flame-retardant needed to actually pass the TB 117 test in 1.0, 1.5 and 1.8 density foams.

TABLE 1
CAL 117 A/D Passing Fire Retardant Levels

| | Example | | | | | | |
|---|---|---|---|---|---|---|---|
| | 1* | 2* | 3 | 4* | 5 | 6* | 7 |
| Foam | 1.8 | 1.8 | 1.8 | 1.5 | 1.5 | 1.0 | 1.0 |
| Density | | | | | | | |
| (lb/ft³) | | | | | | | |
| NDP | 15 | 0 | 7 | 14 | 10 | 30 | 16 |
| Melamine | 0 | 30 | 5 | 0 | 5 | 0 | 5 |
| Foam | Good | Good | Good | Good | Good | Good | Good |
| Appearance | | | | | | | |
| CAL 117 | 2.9″ | Fail/ | 2.7″/ | 3.1″ | 3.2″/ | 3.3″ | 2.9″ |
| A/D | 3.3″ | Fail | 3.8″ | 3.4″ | 3.7″ | 3.6″ | 3.4″ |
| Smolder | 87% | 99% | 91% | 82% | 90% | 98% | 98% |
| Airflow | 4.2 | 3.7 | 4.3 | 5.0 | 4.8 | 4.4 | 4.3 |
| (cfm) | | | | | | | |

*Comparative examples

### EXAMPLES 8-12

### MVSS 302 Test Data

Table 2 presents the performance data for neopentyl glycol bis(diphenyl phosphate) (“NDP”), melamine and their blends. These data illustrate the amounts of flame-retardant needed to pass the MVSS302 automotive test in polyurethane foams of 1.8 and 1.5 lb/ft³ density.

TABLE 2
MVSS 302 Passing levels

| | Example | | | | |
|---|---|---|---|---|---|
| | 8* | 9* | 10 | 11* | 12 |
| Foam | 1.8 | 1.8 | 1.8 | 1.5 | 1.5 |
| Density | | | | | |
| (lb/ft³) | | | | | |
| NDP | 12 | 0 | 8 | 14 | 12 |
| Melamine | 0 | 30 | 5 | 0 | 5 |
| Foam | Good | Good | Good | Good | Good |
| Appearance | | | | | |
| MVSS 302 | SENBR | SENBR | SENBR | SENBR | SENBR |
| | 1.2″ | 0.5″ | 0.5″ | 1.8″ | 0.4″ |
| Airflow | 4.5 | 3.7 | 4.3 | 4.8 | 4.8 |
| (cfm) | | | | | |

*Comparative examples

From an analysis of the data for the CAL 117 AJD and MVSS 302 test data, several conclusions can be reached:

There is an advantage in using the combination of neopentyl glycol bis(diphenyl phosphate) and melamine in a 1.8 lb/ft³ density foam since NDP passes the CAL 117 test at 15 parts and the combination with melamine passes the test with less fire retardant composition (i.e., 7 parts of NDP+5 parts of melamine=12 parts total of flame retardant). The same advantage is observed at 1.0 lb/ft³ where NDP passes the test at 30 parts and the combination with melamine passes the test with considerably less fire retardant composition (i.e., 16 parts of NDP and 5 parts of melamine=21 total parts of flame-retardant composition).

In all cases, the incorporation of melamine results in an improvement in the smoldering test such as in the 1.5 lb/ft³ formulation (82% vs. 90% in the presence of melamine).

In the MVSS 302 test, the combination of NDP and melamine provides lower burn length than those formulations which did not include melamine.

The foregoing Examples merely illustrate certain embodiments of the present invention and, for that reason should not be construed in a limiting sense. The scope of protection that is sought is set forth in the claims that follow.

1. A flame retardant composition which comprises:
a) a major amount by weight of at least one polyphosphate ester flame retardant of the formula: 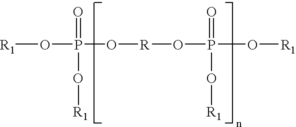
wherein R is an alkylene or arylene group, each R₁ is independently selected to be an alkyl or aryl group, and n is an integer of from 1 to about 10; and,
b) a minor amount by weight of melamine.

2. The flame retardant composition of claim 1 wherein in the polyphosphate ester, each R₁ is a phenyl group.

3. The flame retardant composition of claim 2 wherein the polyphosphate ester is neopentyl glycol bis(diphenyl phosphate).

4. The flame retardant composition of claim 1 containing from about 55 to about 99.5 weight % polyphosphate ester, the balance of the composition being melamine.

5. The flame retardant composition of claim 1 containing from about 80 to about 99 weight % polyphosphate ester, the balance of the composition being melamine.

6. A flame retarded polyurethane foam composition comprising a flame retarding amount of the flame retardant composition of claim 1.

7. The flame retarded polyurethane foam composition comprising a flame retarding amount of the flame retardant composition of claim 2.

8. The flame retarded polyurethane foam composition comprising a flame retarding amount of the flame retardant composition of claim 3.

9. The flame retarded polyurethane foam composition comprising a flame retarding amount of the flame retardant composition of claim 4.

10. The flame retarded polyurethane foam composition comprising a flame retarding amount of the flame retardant composition of claim 5.

11. The flame retarded polyurethane foam composition of claim 6 wherein the polyurethane foam possesses a density of below about 1.5 lb/ft³.

12. The flame retarded polyurethane foam composition of claim 6 wherein the polyurethane foam possesses a density of below about 1.2 lb/ft³.

13. A method of making a flame retarded polyurethane foam which comprises adding a flame retarding amount of flame retardant composition of claim 1 to a polyurethane foam-forming reaction medium and causing the polyurethane foam-forming reaction medium to undergo reaction to provide polyurethane foam containing the flame retardant composition.

14. The method of claim 13 wherein the polyphosphate ester and melamine components of the flame retardant composition are added to the polyurethane foam-forming reaction medium as a blend.

15. The method of claim 14 wherein the blend is added to the polyol-containing component of the polyurethane foam-forming reaction medium.

16. The method of claim 13 wherein in the polyphosphate ester, each R₁ is a phenyl group.

17. The method of claim 13 wherein the polyphosphate ester is neopentyl glycol bis(diphenyl phosphate).

18. The method of claim 13 containing from about 55 to about 99.5 weight % polyphosphate ester, the balance of the composition being melamine.

19. The method of claim 13 containing from about 80 to about 99 weight % polyphosphate ester, the balance of the composition being melamine.

20. The method of claim 14 wherein from about 5 to about 50 parts by weight of the blend are added per 100 parts by weight of the polyol component of the polyurethane foam-forming reaction medium.

21. The method of claim 14 wherein from about 10 to about 30 parts by weight of the blend are added per 100 parts by weight of the polyol component of the polyurethane foam-forming reaction medium.

22. The method of claim 18 wherein from about 5 to about 50 parts by weight of the blend are added per 100 parts by weight of the polyol component of the polyurethane foam-forming reaction medium.

23. The method of claim 18 wherein from about 10 to about 30 parts by weight of the blend are added per 100 parts by weight of the polyol component of the polyurethane foam-forming reaction medium.

24. The method of claim 19 wherein from about 5 to about 50 parts by weight of the blend are added per 100 parts by weight of the polyol component of the polyurethane foam-forming reaction medium.

25. The method of claim 19 wherein from about 10 to about 30 parts by weight of the blend are added per 100 parts by weight of the polyol component of the polyurethane foam-forming reaction medium.

26. The method of claim 13 wherein the polyurethane foam possesses a density below about 1.5 lb/fO.

27. The method of claim 13 wherein the polyurethane foam possesses a density below about 1.2 lb/ft³.
